(19) United States
(12) Patent Application Publication
(10) Pub. No.: US 2020/0133074 A1
(43) Pub. Date: Apr. 30, 2020

(54) LIGHTING DEVICE AND DISPLAY DEVICE

(71) Applicant: SHARP KABUSHIKI KAISHA, Sakai City, Osaka (JP)

(72) Inventors: HISASHI WATANABE, Sakai City, Osaka (JP); HIROTOSHI YASUNAGA, Sakai City, Osaka (JP); YOUZOU KYOUKANE, Sakai City, Osaka (JP)

(21) Appl. No.: 16/607,027

(22) PCT Filed: Apr. 20, 2018
(86) PCT No.: PCT/JP2018/016290

§ 371 Date: Oct. 21, 2019

(30) Foreign Application Priority Data
Apr. 27, 2017 (JP) 2017-088150

(51) Int. Cl. G02F 1/13357

(52) U.S. Cl. CPC G02F 1/133608; G02F 1/133603

(57) ABSTRACT

A lighting device includes a light source, a light source substrate on which the light source is mounted, an optical member disposed to face the light source substrate while having a gap therebetween, and a supporting member being transmissive and disposed between the light source substrate and the optical member. The supporting member is configured to support the optical member and includes at least a light source surrounding portion. The light source surrounding portion and the light source substrate surround the light source therebetween.

### TECHNICAL FIELD

The present invention relates to a lighting device and a display device.

### BACKGROUND ART

Examples of back light devices used for a currently-used liquid crystal display device include one described in Patent Literature 1 as under. The Patent Literature 1 discloses a back light assembly as a back light device including a first plate, a second plate, and a diffusion plate assembly with a plurality of spacers. The first plate is configured to diffuse light. The second plate is disposed to face a surface of the first plate and is configured to block heat transfer toward the first plate. The spacers are interposed between the first plate and the second plate and are configured to separate the first plate and the second plate.

### RELATED ART DOCUMENT

### Patent Literature

Patent Literature 1

Japanese Unexamined Patent Application Publication No. 2008-27885

### Problem to be Solved by the Invention

The back light assembly described in the above Patent Literature 1 includes a lamp and a transparent supporter. The lamp is disposed below the back light assembly. The supporter is secured to a bottom chassis and is configured to support the second plate of the diffusion plate assembly. Accordingly, light emitted from the lamp includes one reaching the diffusion plate assembly directly and one reaching the diffusion plate assembly indirectly through the transparent supporter. The light reaching the diffusion plate assembly through the transparent supporter undergoes a refraction action at least at a boundary between the supporter and an air space, leading to difference in optical path from the light reaching the diffusion plate assembly directly without transmitting the transparent supporter. As a result, the supporter may be identified visually as uneven brightness.

### DISCLOSURE OF THE PRESENT INVENTION

The technology described herein was made in view of the above circumstances. An object is to suppress generation of uneven brightness.

### Means for Solving the Problem

A lighting device according to the present invention includes a light source, a light source substrate on which the light source is mounted, an optical member disposed to face the light source substrate while having a gap therebetween, and a supporting member. The supporting member is transmissive and disposed between the light source substrate and the optical member and is configured to support the optical member. The supporting member includes at least a light source surrounding portion, and the light source surrounding portion and the light source substrate surround the light source therebetween.

With such a configuration, the optical member is supported by the supporting member interposed between the optical member and the light source substrate. Accordingly, the optical member can face the light source substrate by the gap. The light source is surrounded by the light source surrounding portion and the light source substrate. Accordingly, light emitted from the light source reaches the optical member through the light source surrounding portion. Consequently, an optical path difference in light reaching the optical member is more unlikely to be generated than in the configuration in which light reaching the diffusion plate assembly directly and light reaching the diffusion plate assembly indirectly through the transparent supporter are mixed as before. This achieves less generation of uneven brightness in the light exiting from the optical member.

### Advantageous Effect of the Invention

The present invention enables suppressed generation of uneven brightness.

### BRIEF DESCRIPTION OF THE DRAWINGS

FIG. 1 is a plan view of aback light device constituting a liquid crystal display device according to a first embodiment of the present invention.

FIG. 2 is a sectional view of the liquid crystal display device along the A-A line of FIG. 1.

FIG. 3 is a sectional view of the liquid crystal display device along the B-B line of FIG. 1.

FIG. 4 is a plan view of a back light device constituting a liquid crystal display device according to a second embodiment of the present invention.

FIG. 5 is a sectional view of the liquid crystal display device along the C-C line of FIG. 4.

FIG. 6 is a sectional view of the liquid crystal display device along the D-D line of FIG. 4.

FIG. 7 is a plan view of a back light device constituting a liquid crystal display device according to a third embodiment of the present invention.

FIG. 8 is a sectional view of the liquid crystal display device along the A-A line of FIG. 7.

FIG. 9 is a plan view of a back light device constituting a liquid crystal display device according to a fourth embodiment of the present invention.

FIG. 10 is a sectional view of the liquid crystal display device along the C-C line of FIG. 9.

FIG. 11 is a sectional view of the liquid crystal display device along the D-D line of FIG. 9.

FIG. 12 is a plan view of a back light device constituting a liquid crystal display device according to a fifth embodiment of the present invention.

FIG. 13 is a sectional view of the liquid crystal display device along the A-A line of FIG. 12.

FIG. 14 is a sectional view of a liquid crystal display device according to a sixth embodiment of the present invention.

FIG. 15 is a plan view of a back light device constituting a liquid crystal display device according to a seventh embodiment of the present invention.

FIG. 16 is a sectional view of the liquid crystal display device along the A-A line of FIG. 15.

FIG. 17 is a sectional view of the liquid crystal display device along the B-B line of FIG. 15.

FIG. 18 is a plan view of a back light device constituting a liquid crystal display device according to an eighth embodiment of the present invention.

FIG. 19 is a sectional view of the liquid crystal display device along the C-C line of FIG. 18.

FIG. 20 is a sectional view of the liquid crystal display device along the D-D line of FIG. 18.

### MODES FOR CARRYING OUT THE INVENTION

### First Embodiment

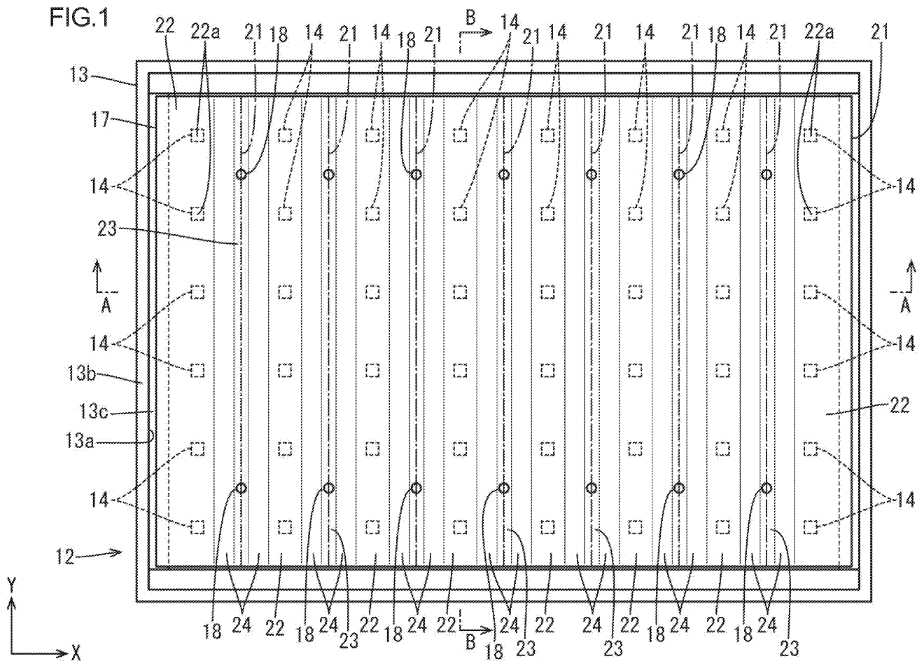

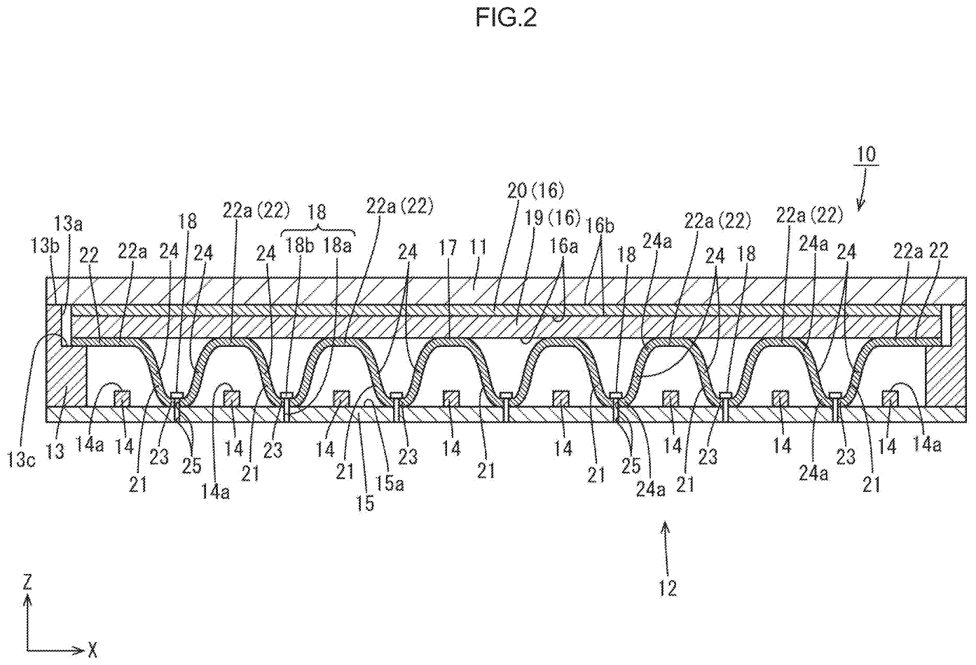

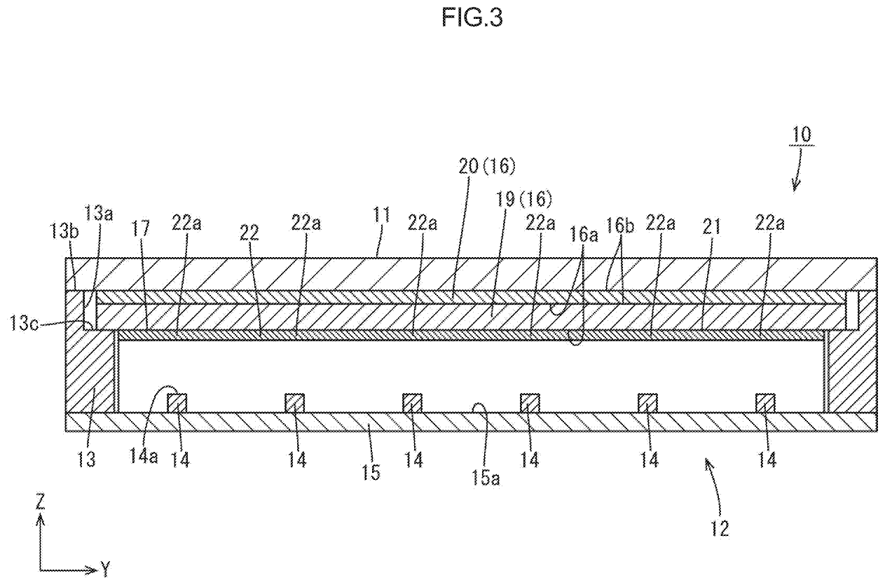

The following describes a first embodiment of the present invention with FIGS. 1 to 3. The present embodiment exemplarily describes a liquid crystal display device (display device) 10. Note that each of drawings partially indicates an X-axis, a Y-axis, and a Z-axis, each of which corresponds to the direction illustrated in the drawing. Moreover, upward and downward directions illustrated in FIGS. 2 and 3 correspond to front and rear sides, respectively.

The liquid crystal display device 10 is substantially rectangle in its entirety. As illustrated in FIG. 2, the liquid crystal display device 10 includes at least a liquid crystal panel (display panel) 11 that is capable of displaying an image, and a back light device (lighting device) 12 as an external light source that is disposed on a rear side (light incidence side) with respect to the liquid crystal panel 11 and is configured to apply light for display to the liquid crystal panel 11. The liquid crystal panel 11 and the back light device 12 includes outer circumferential ends (non-active area) fixed on each other via a light-blocking fixing tape (not shown). The light-shielding fixing tape is, for example, formed by coating double faces of a base with light-blocking property with an adhesive. Note that, instead of the light-blocking fixing tape, a transparent adhesive member such as an optical clear adhesive (OCA) is usable. The liquid crystal display device 10 according to this embodiment is used for a mobile information terminal such as a smartphone and a tablet type terminal, and the liquid crystal panel 11 thereof has a screen size commonly categorized as a middle and small type (e.g., a size of around several inches).

As illustrated in FIG. 2, the liquid crystal panel 11 includes paired glass substrates that adhere to each other by a given gap, and a liquid crystal layer (not shown) between the glass substrates. The liquid crystal layer contains liquid crystal molecules whose optical property is variable as an electric field is applied. One of the glass substrates (array substrate, active matrix substrate) includes an inner surface on which switching elements (e.g., TFTs) and pixel electrodes are arranged two-dimensionally in a matrix array, and on which an alignment film is arranged. The switching elements each includes a source line and a gate line connected thereto. The source line and the gate line intersect each other. The pixel electrodes are each arranged in a rectangle region surrounded by the source lines and the gate lines and are connected to the switching elements. The other of the glass substrates (opposite substrate, CF substrate) includes an inner surface where color filters, a light-shielding layer (black matrix), flat counter electrodes, and an alignment film are arranged. The color filters include coloring portions of R (red), G (green), and B (blue) provided two-dimensionally in given arrangement in a matrix array. The light-shielding layer is disposed between adjacent coloring portions to be formed in a grid shape. The counter electrodes face the pixel electrodes. Moreover, a polarizing plate are provided on outer faces of the glass substrates individually. Moreover, a long side direction, a short side direction, and a thickness direction in the liquid crystal panel 11 correspond to an X-axis direction, a Y-axis direction, and a Z-axis direction, respectively.

The following describes in detail the back light device 12. Similar to the liquid crystal panel 11, the back light device 12 is horizontally rectangle in plan view as illustrated in FIG. 1. As illustrated in FIGS. 1 and 2, the back light device 12 includes a casing 13, an LED (light source) 14, an LED substrate 15, an optical member 16, a supporting member 17, and a fixing member 18. The casing 13 includes a light exiting portion 13a on a front side (adjacent to the liquid crystal panel 11) that is configured to allow light to exit. The LED 14 is accommodated within the casing 13. The LED 14 is bonded on the LED substrate 15. The optical member 16 has a plate or a sheet shape (surface shape), and is disposed on the light exiting portion 13a to face the LED substrate 15 by a gap. The supporting member 17 is disposed between the LED substrate 15 and the optical member 16 to support the optical member 16. The fixing member 18 fixes the supporting member 17 on the LED substrate 15. As described above, the back light device 12 according to this embodiment includes the LED 14 beneath the liquid crystal panel 11 and the optical member 16, and a light exiting face 14a of the LED 14 faces the liquid crystal panel 11 and the optical member 16. This is so-called direct type. The following describes each component of the back light device 12 in detail.

As illustrated in FIGS. 1 and 2, the casing 13 has a box shape (frame shape) extending along the outer circumferential ends of the liquid crystal panel 11 and the optical member 16. The casing 13 is opened on front and rear sides in the Z-axis direction. An opened portion on the front side forms the light exiting portion 13a. The casing 13 is formed by paired long-side portions and paired short-side portions. The long-side portions extend in the long side direction (X-axis direction) of the liquid crystal panel 11 and the optical member 16, whereas the short-side portions extend in the long side direction (Y-axis direction) of the liquid crystal panel 11 and the optical member 16. The casing 13 has a two-step sectional shape. A first step 13b on the front side (uppermost layer) supports the outer circumferential end of the liquid crystal panel 11 from the rear side. A second step 13c on the rear side supports the outer circumferential ends of the optical member 16 and the supporting member 17 from the rear side. Consequently, the light exiting portion 13a of the casing 13 includes the first step 13b on the front side whose opening area is relatively large, and the second step 13c on the rear side whose opening area is relatively small.

As illustrated in FIGS. 1 and 2, the LED 14 is mounted on a surface of the LED substrate 15. The light exiting face 14a of the LED 14 faces opposite to the LED substrate 15 (toward the front side). This is so-called surface light-exiting type. The LED 14 is disposed in a positional relationship where the light exiting face 14a faces plate faces of the optical member 16 and the supporting member 17. The LED 14 is configured in such a manner that an LED chip (LED element) as a semiconductor light exiting device is sealed on a substrate portion adhering to a plate face of the LED substrate 15 with a sealant. The LED chip emits monochromatic light, such as blue light, and luminescent substances (e.g., yellow luminescent substance, green luminescent substance, red luminescent substance) are dispersed and compounded in the sealant. Consequently, the LED 14 emits white light entirely. A distribution of luminous intensity in the LED 14 in plan view has the tendency that an amount of luminescence becomes the maximum at the central position of the LED 14, and gradually decreases as the distance from the central position increases, which is closely analogous to a normal distribution. Accordingly, an area of the optical member 16 and the supporting member 17 overlapping the LED 14 in plan view corresponds to an area where an amount of light emitted from the LED 14 directly is the maximum.

As illustrated in FIGS. 1 and 2, the LED substrate 15 has a rectangular plate shape in plan view like the liquid crystal panel 11, and is configured to close an opened portion of the casing 13 on the rear side. The LED substrate 15 includes a plate face on the front side that faces the optical member 16, corresponding to a bonding surface 15a on which the LEDs 14 configured as above are bonded. A plurality of LEDs 14 is spaced apart from one another in the X-axis direction (row direction) and the Y-axis direction (column direction), respectively, in a row and column manner within the bonding surface 15a of the LED substrate 15. In this embodiment, eight LEDs 14 in the X-axis direction, and six LEDs 14 in the Y-axis direction, i.e., 48 LEDs 14 in total are arranged by substantial equal gaps. The LED substrate 15 is made from metal such as an aluminum-based material. The LED substrate 15 includes a surface on which a wiring pattern (not shown) made of a metal film such as a copper foil is formed via an insulating layer, and includes an outermost surface on which a reflection layer (not shown) in white is formed. The reflection layer reflects light emitted from the LEDs 14 and returned toward the LED substrate 15. Consequently, the reflected light is deflected upward to the front side to use as exiting light. Note that an insulating material such as ceramic is usable as the material for a base of the LED substrate 15. Moreover, a similar light reflecting function is obtainable by laminating a reflection sheet made from a material different from that of the LED substrate 15 (such as a sheet made from a synthetic resin material whose surface is white (e.g., PET)) on the outermost surface of the LED substrate 15.

As illustrated in FIG. 2, the optical member 16 has a rectangular plate or sheet shape in plan view, which is similar to the liquid crystal panel 11 and the LED substrate 15. The optical member 16 is disposed between the liquid crystal panel 11 and the LEDs 14 in the Z-axis direction. The optical member 16 has the function to allow the LEDs 14 to emit light to the liquid crystal panel 11 while applying given optical action to the emitted light. The optical member 16 faces the LEDs 14 by a given gap toward the front side, i.e., the light exiting side, and is supported by the casing 13 and the supporting member 17 from the rear side. This maintains a substantially constant gap between the optical member 16 and the LEDs 14. The optical member 16 includes a rear plate facing the bonding surface 15a of the LED substrate 15 as a light incident face 16a where light enters, and a front plate facing the liquid crystal panel 11 as a light exiting surface 16b through which light exits.

As illustrated in FIG. 2, the optical member 16 includes two types of plates, i.e., a diffuser plate 19 and an optical sheet 20. Among them, the diffuser plate 19 is supported on the second step 13c on the rear side in the casing 13 via the supporting member 17. The optical sheet 20 is laminated directly on the front side of the light exiting surface 16b of the diffuser plate 19 for achieving support. The diffuser plate 19 has a thickness larger than that of other types of the optical sheet 20. The diffuser plate 19 is configured by dispersing many diffusion particles (diffusing agent) in the base (light transmitting plate) made from a substantially transparent synthetic resin material (e.g., polycarbonate and acryl). The diffuser plate 19 has a function to diffuse transmitted light. The thickness of the diffuser plate 19 is smaller than that of a diffuser plate provided in a liquid crystal display device which is used for a television receiver, for example, and whose liquid crystal panel has a large screen size. The thickness of the diffuser plate 19 is in a range of 0.5 to 3 mm, for example. Examples of the optical sheet 20 include a diffusion sheet, a prism sheet, a reflective polarization sheet. One or more of them are selectively usable. The thickness of the optical sheet 20 is smaller than the thickness of the diffuser plate 19.

As illustrated in FIG. 1, the supporting member 17 has a rectangular sheet shape in plan view, which is similar to the LED substrate 15 and the optical member 16, and its size in plan view is substantially equal to those of the LED substrate 15 and the optical member 16. The supporting member 17 is interposed in its entirety between the LED substrate 15 and the diffuser plate 19 as the optical member 16 in the Z-axis direction (a normal line of the plate faces of the LED substrate 15 and the optical member 16). The supporting member 17 supports the diffuser plate 19 directly from the rear side, achieving a substantially constant gap between the diffuser plate 19 and the LED 14 almost entirely. The supporting member 17 is made from a synthetic resin material (e.g., polycarbonate) with translucency that is substantially transparent. Accordingly, the supporting member 17 allows light from the LED 14 to pass through and enter into the optical member 16 without blocking the light although the supporting member 17 is interposed between the light exiting face 14a of the LED 14 and the light incident face 16a of the diffuser plate 19. Moreover, the supporting member 17 includes both ends in the X-axis direction that are supported on the second step 13c on the rear side in the casing 13. Moreover, the supporting member 17 has a thickness smaller than that of the diffuser plate 19 to be supported. The thickness is, for example, in a range of 0.2 to 1 mm.

As illustrated in FIGS. 2 and 3, the supporting member 17 includes an LED surrounding portion 21 and the LEDs 14 are surrounded between the LED surrounding portion 21 and the LED substrate 15. With such a configuration, most of the light emitted from the LEDs 14 passes through the LED surrounding portion 21 to the optical member 16. Consequently, an optical path difference in light reaching the optical member 16 is more unlikely to be generated than in the configuration in which light reaching the diffuser plate assembly directly and light reaching the diffuser plate assembly indirectly through the transparent supporter are mixed. This achieves less generation of uneven brightness in the light exiting from the optical member 16. In addition, as illustrated in FIGS. 1 and 3, the LED surrounding portion 21 extends in the Y-axis direction (a column direction) in such a manner as to surround all the LEDs 14 arranged in the Y-axis direction collectively, and has substantially a strip shape in plan view. With such a configuration, the supporting member 17 has a simpler configuration and reduction in production cost thereof is obtainable in comparison to the case where drawing is needed even when two or more LED surrounding portions are arranged in a row and column manner like the LEDs 14. Moreover, as illustrated in FIG. 1, the supporting member 17 includes the LED surrounding portions 21 arranged in the X-axis direction alternately in a successive manner. Note that FIG. 1 illustrates a terminal position of every LED surrounding portion 21 by alternate long and short dashed lines.

As illustrated in FIG. 2, the LED surrounding portion 21 includes at least an optical member contacting portion (diffuser plate contacting portion) 22 and a substrate contacting portion 23. The optical member contacting portion 22 contacts the diffuser plate 19 as the optical member 16. The substrate contacting portion 23 contacts the LED substrate 15. With such a configuration, each component is arrangeable with higher efficiency in the supporting member 17 than in the case where the optical member contacting portion and the substrate contacting portion are provided separately from the LED surrounding portion 21. Moreover, with the above configuration, the LED surrounding portion 21 forms a closed space between the LED surrounding portion 21 and the LED substrate 15. The closed space surrounds the LEDs 14 with a height to the diffuser plate 19. This allows the light from the LEDs 14 to pass through the LED surrounding portion 21 with less leakage. The optical member contacting portions 22 extend in the X-axis direction and the Y-axis direction in parallel to the light incident face 16a of the diffuser plate 19 as the optical member 16. With such a configuration, the optical member contacting portions 22 are in surface contact with the optical member 16, achieving more stable support of the optical member 16. Especially, the LED surrounding portion 21 according to this embodiment has substantially a strip shape to extend in such a manner as to cover all the LEDs 14 arranged in the Y-axis direction. Moreover, the LED surrounding portion 21 surrounds the LEDs 14 collectively. This ensures a large contact region (contact area) of the optical member contacting portion 22 with respect to the diffuser plate 19 as the optical member 16, leading to more stable support of the optical member 16. From the above, even when the diffuser plate 19 to be supported by the supporting member 17 is thinner than the diffuser plate provided in the liquid crystal display device with a liquid crystal panel whose screen size is large, the supporting member 17 supports the diffuser plate 19 stably. This generates less deformation such as bending or warp in the diffuser plate 19. Moreover, a large amount of light emitted from the LEDs 14 is applied to a portion of the LED surrounding portion 21 overlapping the LEDs 14.

Moreover, as illustrated in FIG. 2, the optical member contacting portion 22 constitutes an LED overlapping portion (light source overlapping portion) 22a arranged in such a manner that a part thereof overlaps the LEDs 14. As already described, a large amount of light emitted from the LEDs 14 is applied to the LED overlapping portion 22a. On the other hand, the LED overlapping portion 22a is a part of the optical member contacting portion 22 contacting the diffuser plate 19 as the optical member 16. Consequently, a large amount of light from the LEDs 14 described above passes through the optical member contacting portion 22 and the optical member 16 successively. As a result, an optical path difference in incident light to the diffuser plate 19 as the optical member 16 is more unlikely to be generated than in the case where the light having passed through the LED overlapping portion enters the diffuser plate 19 as the optical member 16 via the air space if the LED overlapping portion is spaced apart from the optical member 16. This leads to much less uneven brightness. In addition, the substrate contacting portion 23 extends in the Y-axis direction in parallel to the bonding surface 15a of the LED substrate 15 to contact the surface of the LED substrate 15. Note noted that the optical member contacting portion 22 has a width (dimension in the X-axis direction) larger than that of the substrate contacting portion 23.

As illustrated in FIG. 2, the LED surrounding portion 21 includes at least an optical member spacer (diffuser plate spacer) 24. The optical member spacer 24 is connected to the optical member contacting portion 22 and the substrate contacting portion 23 and is spaced apart from the diffuser plate 19 as the optical member 16 toward the rear side (toward the LED substrate 15). The optical member spacer 24 is oblique in its entirety with respect to the optical member contacting portion 22 and the substrate contacting portion 23. Moreover, the optical member spacer 24 includes a curved portion 24a whose section along the X-axis direction is curved. The curved portion 24a is disposed at a boundary between the optical member contacting portion 22 and the substrate contacting portion 23 individually. With such a configuration, the boundary between the optical member spacer 24 spaced apart from the optical member 16 toward the LED substrate 15 and the optical member contacting portion 22 contacting the optical member 16 is more unlikely to be identified visually as the uneven brightness than in the case where the optical member spacer includes no curved portion and thus has a linear section in its entirety.

The following describes the fixing member 18. As illustrated in FIGS. 1 and 2, the fixing member 18 inserted into an attaching hole 25 as a through hole in the LED substrate 15 and the supporting member 17, thereby fixing the supporting member 17 to the LED substrate 15 in an attached manner. The attaching hole 25 adjacent to the supporting member 17 is formed in the substrate contacting portion 23. The fixing member 18 is formed by a shaft inserting portion 18a inserted into the attaching hole 25, and a collar pressing portion 18b configured to press the supporting member 17 from a front side thereof. In addition, the fixing member 18 are arranged two-dimensionally in a staggered manner with respect to the LEDs 14 arranged within the surface of the LED substrate 15 in a row and column manner. In other words, the fixing member 18 is offset from the LEDs 14 so as not to conform to each other in the X-axis direction and the Y-axis direction, and is arranged obliquely from the LEDs 14 with respect to the X-axis direction and the Y-axis direction. With such a configuration, in-line arrangement of the fixing members 18 likely to be identified visually as a dark portion and the LEDs 14 likely to be identified visually as a bright portion is avoidable, leading to less uneven brightness.

As described above, the back light device (lighting device) 12 according to this embodiment includes the LED (light source) 14, the LED substrate (light source substrate) 15 on which the LED 14 is bonded, the optical member 16 disposed to face the LED substrate 15 by the gap, and the translucent supporting member 17. The supporting member 17 is interposed between the LED substrate 15 and the optical member 16, and is configured to support the optical member 16. The supporting member 17 includes at least the LED surrounding portion (light source surrounding portion) 21 configured to surround the LED 14 with the LED substrate 15.

With such a configuration, the optical member 16 is supported by the supporting member 17 interposed between the optical member 16 and the LED substrate 15. Accordingly, the optical member 16 can face the LED substrate 15 by the gap. The LEDs 14 are surrounded between the LED surrounding portion 21 of the supporting member 17 and the LED substrate 15. Accordingly, light emitted from the LEDs 14 reaches the optical member 16 through the LED surrounding portion 21. Consequently, an optical path difference in light reaching the optical member 16 is more unlikely to be generated than in the configuration in which light reaching the diffuser plate assembly directly and light reaching the diffuser plate assembly indirectly through the transparent supporter are mixed as before. This achieves less generation of uneven brightness in the light exiting from the optical member 16.

Moreover, the LED surrounding portion 21 includes at least an optical member contacting portion 22 configured to contact the optical member 16. With such a configuration, each component is arrangeable with higher efficiency in the supporting member 17 than in the case where the optical member contacting portion is provided separately from the LED surrounding portion 21.

Moreover, the optical member contacting portion 22 extends in parallel to a surface of the optical member 16 in such a manner as to overlap the LEDs 14 at least partially. With such a configuration, the optical member contacting portion 22 is in surface contact with the optical member 16, achieving more stable support of the optical member 16. Here, a large amount of light emitted from the LEDs 14 is applied to a portion of the LED surrounding portion 21 overlapping the LEDs 14. Moreover, since the optical member contacting portion 22 of the LED surrounding portion 21 overlaps the LEDs 14 at least partially, a large amount of light emitted from the LEDs 14 passes through the optical member contacting portion 22 and the optical member 16 successively. As a result, an optical path difference in incident light to the optical member 16 is more unlikely to be generated than in the case where the light having passed through a region overlapping the LEDs 14 enters the optical member 16 via the air space if the region of the LED surrounding portion 21 overlapping the LEDs 14 is spaced apart from the optical member 16. This leads to much less uneven brightness.

Moreover, the LEDs 14 are spaced apart from one another by gaps within the surface of the LED substrate 15. The LED surrounding portion 21 is arranged in such a manner as to surround the LEDs 14 collectively. The optical member contacting portion 22 extends at least partially across the LEDs 14. With such a configuration, at least a part of the optical member contacting portion 22 of the LED surrounding portion 21 surrounding the LEDs 14 collectively is in surface contact with the optical member 16 while extending across the LEDs 14, achieving more stable support of the optical member 16.

Moreover, the LED surrounding portion 21 includes at least the optical member spacer 24. The optical member spacer 24 is connected to the optical member contacting portion 22 and is spaced apart from the optical member 16 toward the LED substrate 15. The optical member spacer 24 has a curved sectional shape. With such a configuration, the boundary between the optical member spacer 24 spaced apart from the optical member 16 toward the LED substrate 15 and the optical member contacting portion 22 contacting the optical member 16 is more unlikely to be identified visually as the uneven brightness than in the case where the optical member spacer has a linear sectional shape.

Moreover, the LED surrounding portion 21 includes at least a substrate contacting portion 23 configured to contact the LED substrate 15. With such a configuration, each component is arrangeable with higher efficiency in the supporting member 17 than in the case where the substrate contacting portion is provided separately from the LED surrounding portion 21.

Moreover, the LEDs 14 are spaced apart from one another by gaps within a surface of the LED substrate 15 in a row and column manner, and the fixing members 18 are provided two-dimensionally in a staggered manner with respect to the LEDs 14 to fix the LED substrate 15 on the substrate contacting portion 23. With such a configuration, the fixing members 18 configured to fix the LED substrate 15 on the substrate contacting portion 23 are disposed two-dimensionally in a staggered manner with respect to the LEDs 14 spaced apart by gaps in a row and column manner. Accordingly, in-line arrangement of the fixing members 18 likely to be identified visually as a dark portion and the LEDs 14 likely to be identified visually as a bright portion is avoidable. This achieves less generation of uneven brightness.

Moreover, the LEDs 14 are spaced apart from one another by gaps within a surface of the LED substrate 15 in a row and column manner. The LED surrounding portion 21 extends along a row direction or a column direction of the LEDs 14 in such a manner as to surround the LEDs 14 collectively. With such a configuration, the supporting member 17 has a simpler configuration than in the case where the LED surrounding portions are spaced apart by gaps in a row and column manner like the LEDs 14. Consequently, such a configuration is suitable for reduction in production cost of the supporting member 17.

Moreover, the liquid crystal display device (display device) 10 according to this embodiment includes the back light device 12 described above, and a liquid crystal panel (display panel) 11 configured to display an image with use of light applied from the back light device 12. The liquid crystal display device 10 with such a configuration makes it difficult to generate uneven brightness in the light emitted from the back light device 12, achieving display with high display quality.

### Second Embodiment

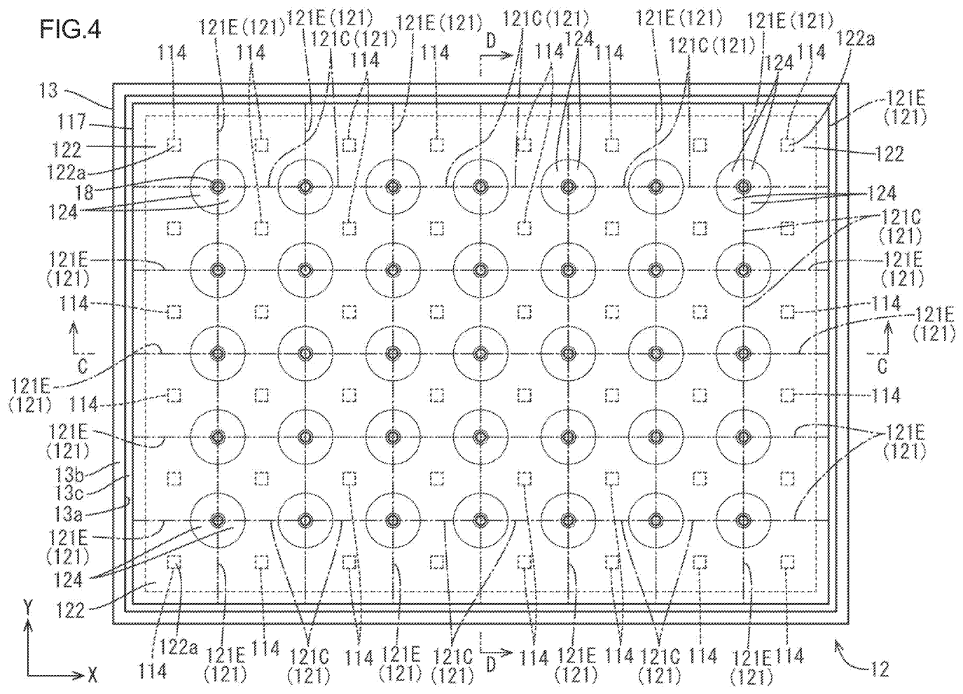

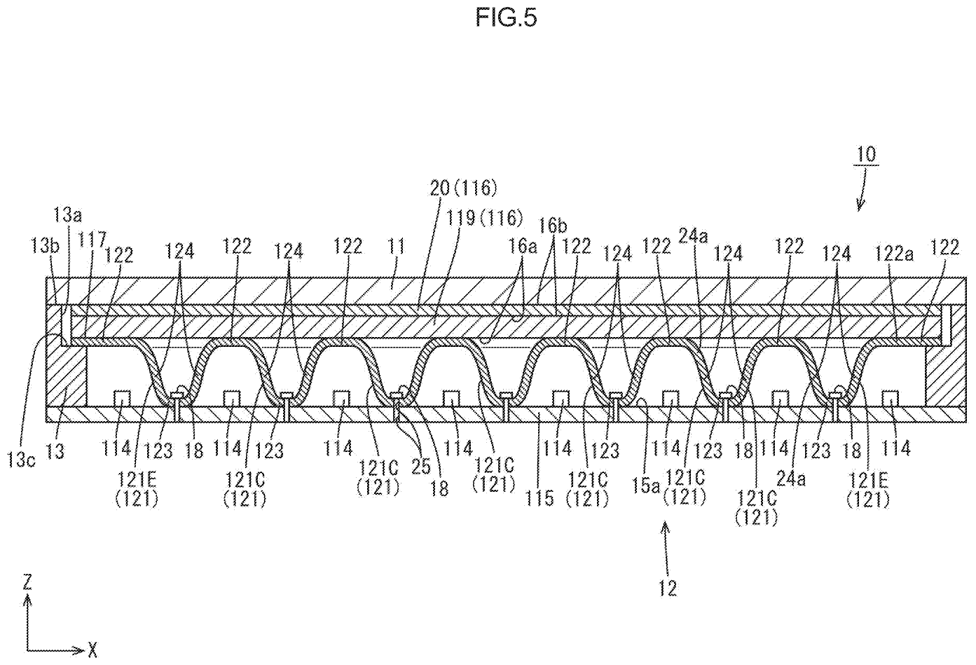

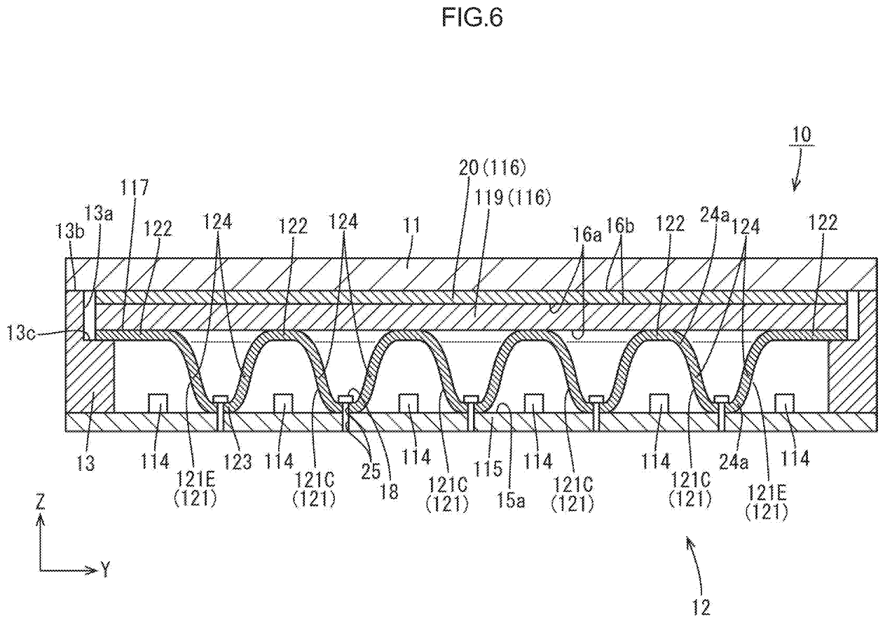

The following describes a second embodiment of the present invention with FIGS. 4 to 6. In the second embodiment, a LED surrounding portion 121 includes a varied configuration. Here, the description of the configuration and operational advantage common to that of the first embodiment described above is to be omitted.

As illustrated in FIGS. 4 to 6, a supporting member 117 according to this embodiment includes a plurality of LED surrounding portions 121 within the surface of the LED substrate 115 arranged in a row and column manner. The LED surrounding portions 121 are each formed by an optical member contacting portion 122, a substrate contacting portion 123, and an optical member spacer 124. The optical member contacting portion 122 includes an LED overlapping portion 122a overlapping one LED 114. The substrate contacting portion 123 is arranged in a staggered manner with respect to the LEDs 114. The optical member spacer 124 connects the optical member contacting portion 122 and the substrate contacting portion 123. The LED surrounding portion 121 has substantially a square shape in plan view, and the center thereof in plan view substantially conforms to the center of the LED 114. Moreover, the number of LED surrounding portions 121 is equal to the number of LEDs 114. Note that FIG. 4 illustrates a terminal position of every LED surrounding portion 121 by alternate long and short dashed lines.

As illustrated in FIG. 4, the LED surrounding portions 121 arranged in a row and column manner each include a plurality of external LED surrounding portions 121E and a plurality of central LED surrounding portions 121C. The external LED surrounding portions 121E are disposed to surround the LEDs 114 at the outermost periphery within the surface of the LED substrate 115. The central LED surrounding portions 121C are disposed toward the center with respect to the external LED surrounding portions 121E. The central LED surrounding portion 121C includes substrate contacting portions 123 at corner portions of four corners, respectively, in the optical member contacting portion 122. The external LED surrounding portion 121E includes the substrate contacting portions 123 at corner portions, respectively, that are each adjacent to the central LED surrounding portion 121C. The four LED surrounding portions 121 adjacent to each other in the X-axis direction and the Y-axis direction include four substrate contacting portions 123 individually that are connected to each other. The four substrate contacting portions 123 connected one another form a circular shape in plan view.

Moreover, as illustrated in FIGS. 4 to 6, the LED surrounding portions 121 adjacent to each other in the X-axis direction and the Y-axis direction are connected via the optical member contacting portions 122 individually. The optical member contacting portions 122 adjacent to each other in the X-axis direction and the Y-axis direction are connected to each other, thereby extending in the X-axis direction and the Y-axis direction to form a substantially grid shape in its entirety in plan view. The diffuser plate 119 as the optical member 116 is supported by a group of optical member contacting portions 122 connected to each other in such a manner as above to form the substantially grid planar shape. This achieves more stable support of the optical member 116. In addition, the LED surrounding portions 121 in this embodiment surround the LEDs 114 between the LED surrounding portions 121 and the LED substrate 115. On the other hand, the adjacent optical member contacting portions 122 are connected to each other. This generates no closed space like the one in the first embodiment between the LED surrounding portions 121 and the LED substrate 115.

According to this embodiment described above, the LEDs 114 and the LED surrounding portions 121 are arranged in a row and column manner within the surface of the LED substrate 115. The LED surrounding portions 121 includes at least the optical member contacting portions 122 each contacting the optical member 116. The adjacent optical member contacting portions 122 are connected. With such a configuration, the LED surrounding portions 121 spaced apart by gaps within the surface of the optical member 116 in a row and column manner includes the optical member contacting portions 122, the adjacent optical member contacting portions 122 being connected to each other. This achieves suitable support of the optical member 116 with the optical member contacting portions 122 connected to each other.

### Third Embodiment

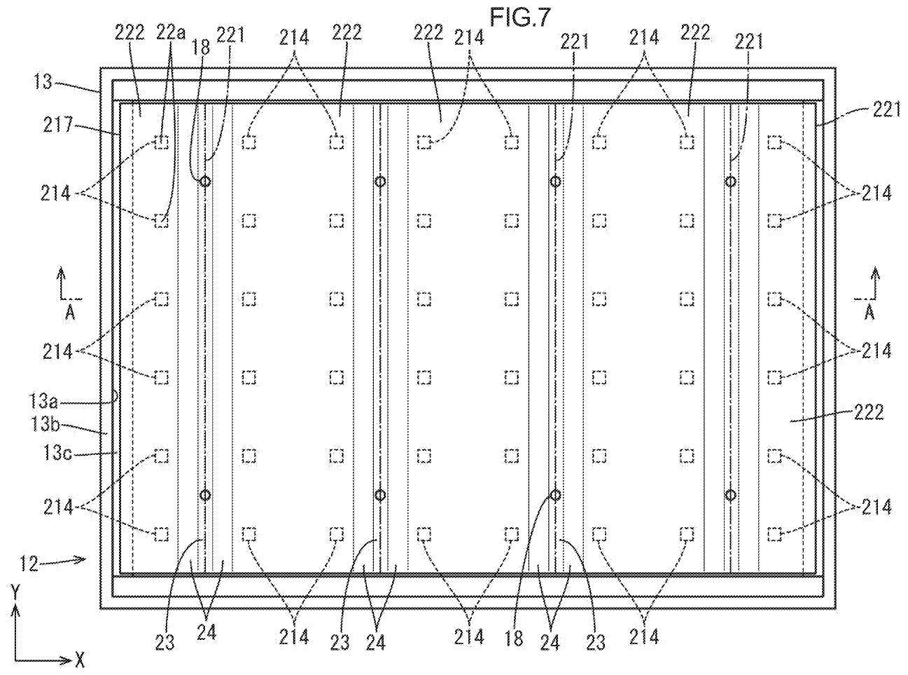

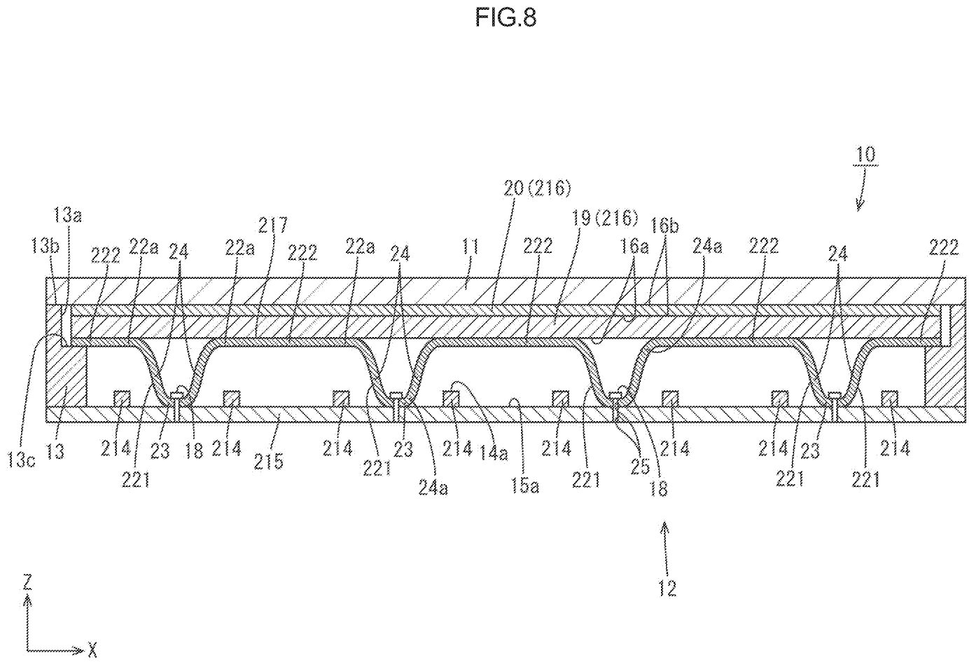

The following describes a third embodiment of the present invention with FIG. 7 or 8. The third embodiment illustrates a variation in configuration of an LED surrounding portion 221 based on the first embodiment described above. Here, the description of the configuration and operational advantage common to that of the first embodiment described above is to be omitted.

As illustrated in FIGS. 7 to 8, a supporting member 217 according to this embodiment includes LED surrounding portions 221 arranged in such a manner as to surround a plurality of LEDs 214 collectively that are disposed between the LED surrounding portions 221 and an LED substrate 215 in the X-axis direction. Note that FIG. 7 illustrates a terminal position of every LED surrounding portion 221 by alternate long and short dashed lines. Specifically, one of the LED surrounding portions 221 arranged on both ends in the X-axis direction surrounds one LED 214 in the X-axis direction between the LED surrounding portion 221 and the LED substrate 215 in the same manner as the LED surrounding portion 21 (see FIG. 1) described above in the first embodiment. In contrast to this, the other of the LED surrounding portions 221 arranged at the center in the X-axis direction surround two LEDs 214 in the X-axis direction between the LED surrounding portion 221 and the LED substrate 215 collectively. The optical member contacting portions 222 extend in the X-axis direction and also in the Y-axis direction in such a manner as to cover the LEDs 214. In other words, the optical member contacting portions 222 of the LED surrounding portion 221 surrounding the LEDs 214 collectively in the X-axis direction and the Y-axis direction are in surface contact with the optical member 216 while extending across the LEDs 214 in the X-axis direction and the Y-axis direction, achieving more stable support of the optical member 216.

### Fourth Embodiment

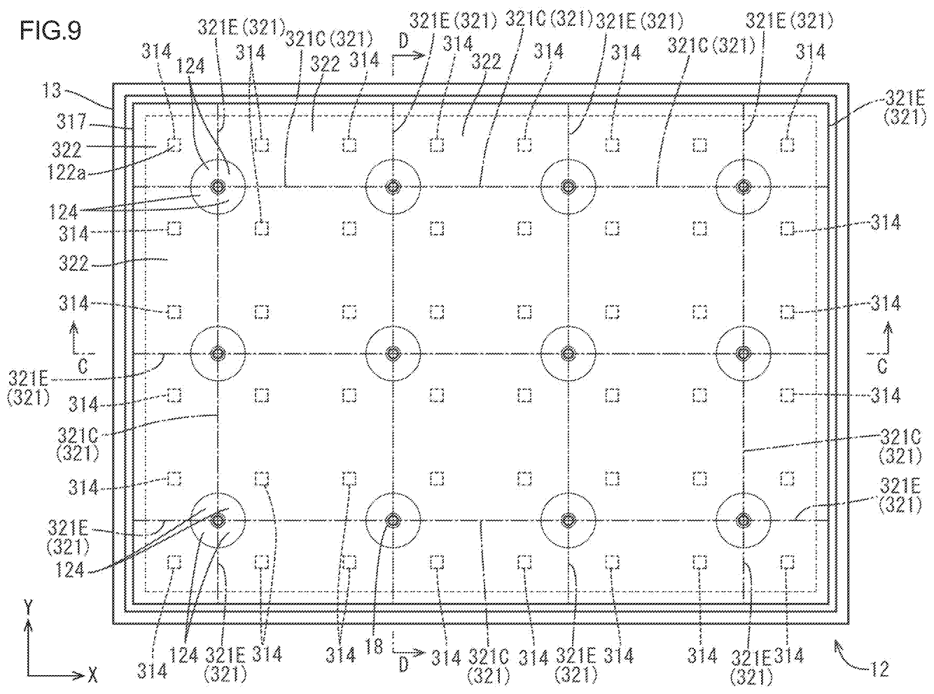

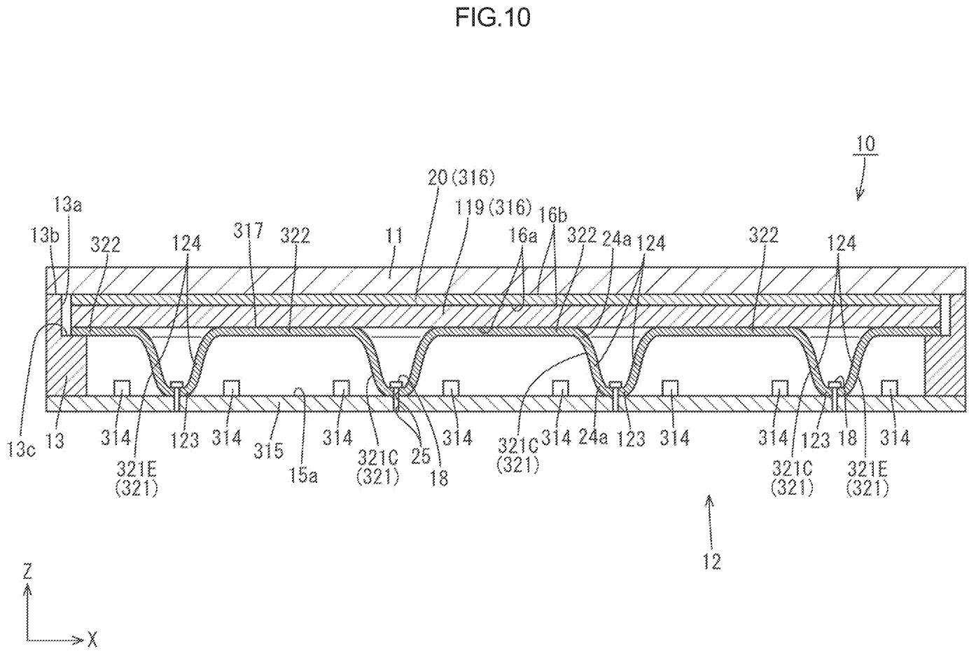

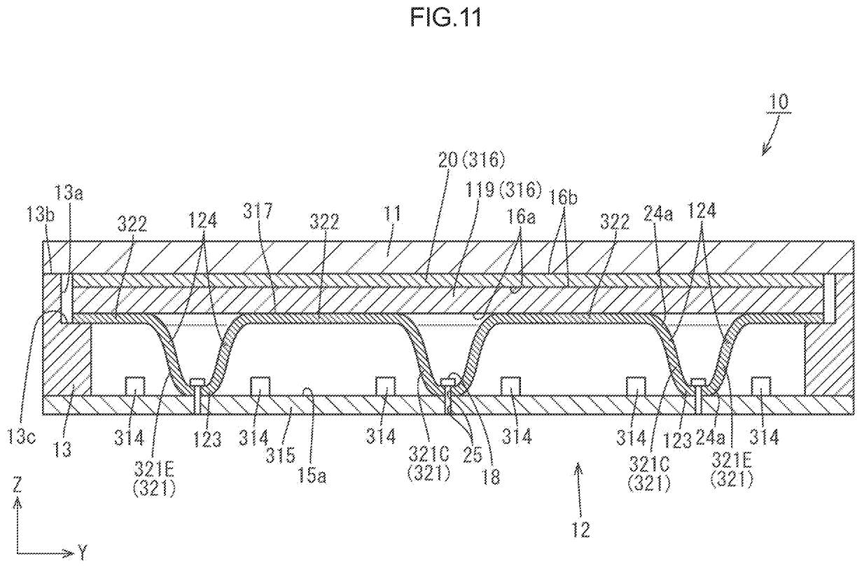

The following describes a fourth embodiment of the present invention with FIGS. 9 to 11. The fourth embodiment illustrates a variation in configuration of an LED surrounding portion 321 based on the second embodiment described above. Here, the description of the configuration and operational advantage common to that of the second embodiment described above is to be omitted.

As illustrated in FIGS. 9 to 11, a supporting member 317 according to this embodiment includes LED surrounding portions 321 arranged in such a manner as to surround a plurality of LEDs 314 collectively that are disposed between the LED surrounding portions 321 and an LED substrate 315 in the X-axis direction. Note that FIG. 9 illustrates a terminal position of every LED surrounding portion 321 by alternate long and short dashed lines. Specifically, external LED surrounding portions 321E of the LED surrounding portions 321 arranged in the X-axis direction and the Y-axis direction each surround one LED 314 between the external LED surrounding portions 321E and the LED substrate 315 in the same manner as the external LED surrounding portions 121E (see FIG. 4) described above in the second embodiment. In contrast to this, central LED surrounding portions 321C each surround two LEDs 214 arranged in the X-axis direction and the X-axis direction between the central LED surrounding portion 321C and the LED substrate 315, i.e., four LEDs 314 in total collectively. The optical member contacting portions 322 extend in such a manner as to cover the two LEDs 314 in the X-axis direction and the Y-axis direction. With such a configuration described above, similar to the third embodiment described above, the optical member contacting portions 322 extending in such a manner as to cover the LEDs 314 in the X-axis direction and the Y-axis direction are in surface contact with the optical member 316, achieving more stable support of the optical member 316.

### Fifth Embodiment

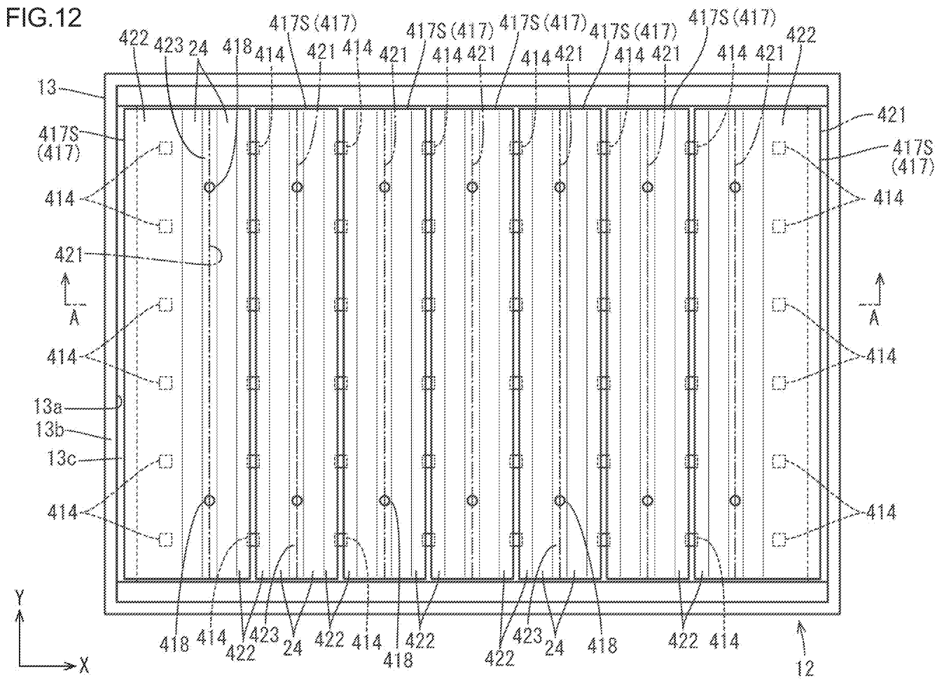

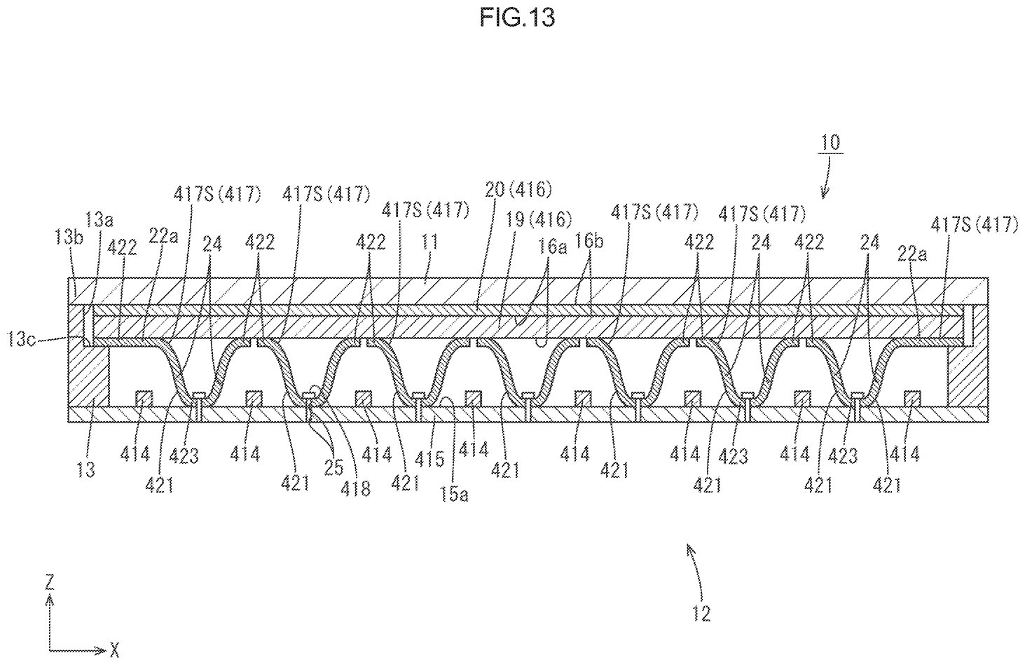

The following describes a fifth embodiment of the present invention with FIG. 12 or 13. The fifth embodiment illustrates a variation in configuration of a supporting member 417 based on the first embodiment described above. Here, the description of the configuration and operational advantage common to that of the first embodiment described above is to be omitted.

As illustrated in FIGS. 12 to 13, the supporting member 417 according to this embodiment is formed by a plurality of separated supporting members 417S. The supporting member 417 is formed by the separated supporting members 417S as described above, achieving difficulty in deformation due to thermal expansion. Specifically, the supporting member 417 is separated into plural parts along a separation in the Y-axis direction as a boundary. Accordingly, the supporting member 417 is formed by the separated supporting members 417S arranged in the X-axis direction, and a boundary position between the adjacent separated supporting members 417S overlaps an LED 414 in plan view. That is, the LED surrounding portion 421 is formed by the two separated supporting members 417S adjacent to each other in the X-axis direction and an optical member contacting portion 422 is separated into two parts in the X-axis direction. In this embodiment, the number of separated supporting members 417S is a number (seven) obtained by subtracting one from the number (eight) of LEDs 414 in the X-axis direction. As described above, the optical member contacting portion 422 is separated, whereby a substrate contacting portion 423 is not separated. This can cause the fixing member 418 to fix the substrate contacting portion 423 on the LED substrate 415 more stably. Note that FIG. 12 illustrates a terminal position of every LED surrounding portion 421 by alternate long and short dashed lines.

According to this embodiment described above, the LED surrounding portion 421 includes at least the optical member contacting portions 422 contacting the optical member 416, and the substrate contacting portions 423 contacting the LED substrate 415. The supporting member 417 is formed by the separated supporting members 417S each obtained by separating the optical member contacting portions 422. With such a configuration, the supporting member 417 is formed by the separated supporting members 417S, achieving difficulty in deformation due to thermal expansion. The separated supporting members 417S are formed by separating the optical member contacting portions 422, whereas the substrate contacting portions 423 are not separated. Accordingly, this achieves stable fixation of the LED substrate 415 when the substrate contacting portions 423 are fixed on the LED substrate 415.

### Sixth Embodiment

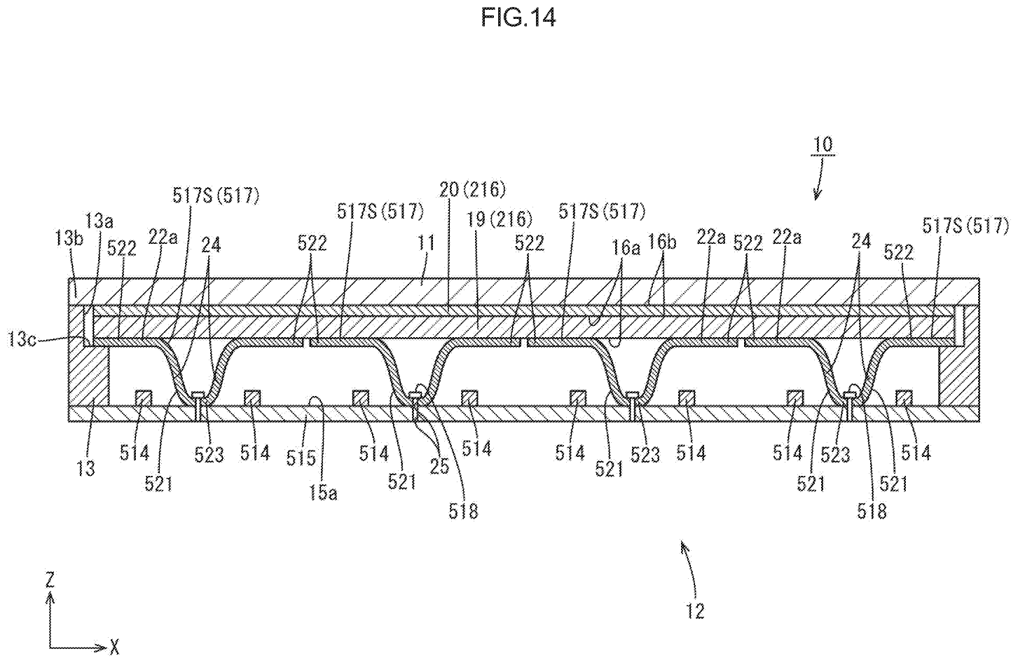

The following describes a sixth embodiment of the present invention with FIG. 14. The sixth embodiment illustrates a variation in configuration of a supporting member portion 517 based on the third embodiment described above. Here, the description of the configuration and operational advantage common to that of the third embodiment described above is to be omitted.

As illustrated in FIG. 14, the supporting member portion 517 according to this embodiment is formed by a plurality of separated supporting members 517S as in the fifth embodiment described above, but the number by which the separated supporting members 517S is separated is smaller than that in the fifth embodiment described above. This obtains excellent working efficiency for attaching the separated supporting members 517S to the LED substrate 515. Specifically, in this embodiment, the number by which the separated supporting member 517S is separated is four. Among five LED surrounding portions 521, LED surrounding portions 521 that are arranged at the center in the X-axis direction each surround two LEDs 514 arranged in the X-axis direction between the LED surrounding portion 521 and the LED substrate 515, and are each formed by two separated supporting members 517S adjacent to each other in the X-axis direction. Moreover, optical member contacting portions 522 of the LED surrounding portions 521 are each separated into two parts in the X-axis direction. A separating position of the optical member contacting portion 522 does not overlap the LEDs 514, but is located at a middle point of the two LEDs 514 arranged in line in the X-axis direction. As described above, the optical member contacting portions 522 are separated, whereby the substrate contacting portions 523 are not separated. This can cause the fixing member 518 to fix the substrate contacting portions 523 on the LED substrate 515 more stably.

### Seventh Embodiment

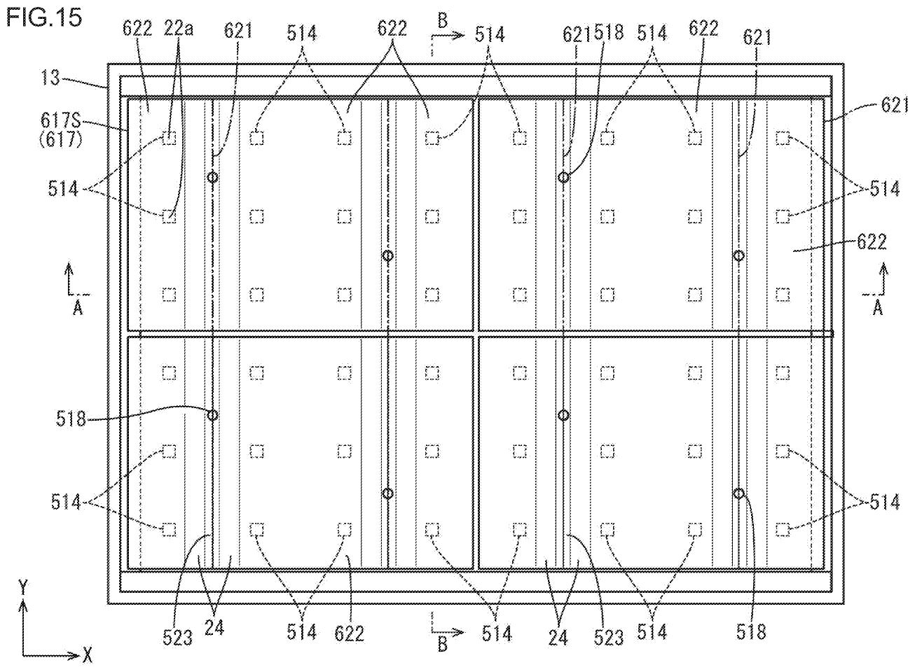

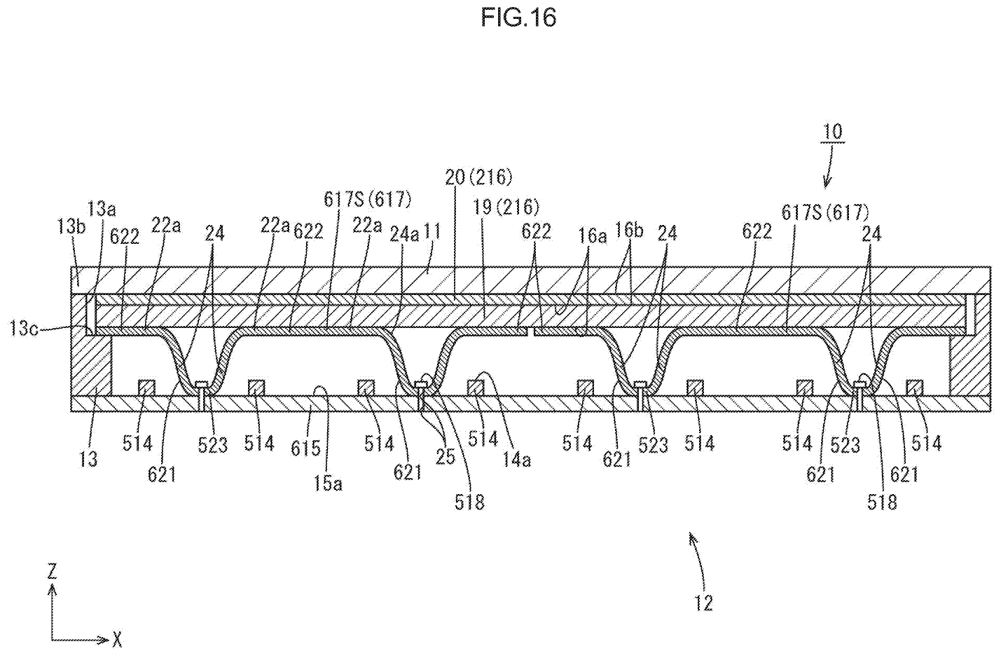

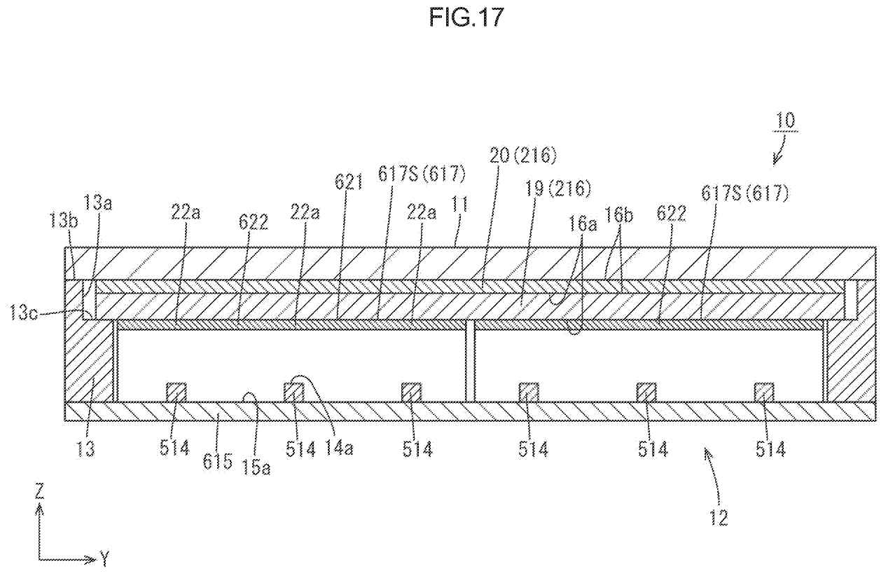

The following describes a seventh embodiment of the present invention with FIGS. 15 to 17. The seventh embodiment illustrates a variation in configuration of a supporting member 617 based on the sixth embodiment described above. Here, the description of the configuration and operational advantage common to that of the sixth embodiment described above is to be omitted.

As illustrated in FIGS. 15 to 17, the supporting member 617 according to this embodiment is formed by a plurality of separated supporting members 617S as in the fifth and sixth embodiments described above, but the number by which the separated supporting members 617S is separated is much smaller than that in the sixth embodiment. This obtains more excellent working efficiency for attaching the separated supporting members 617S to the LED substrate 615. Specifically, in this embodiment, the number by which the separated supporting member 617S is separated is four, and two of them are arranged in the X-axis direction and the Y-axis direction, respectively, within a surface of the LED substrate 615. In other words, the supporting member 617 is disposed at a center position with respect to its X-axis and Y-axis directions, and is separated along a separation as a boundary in the X-axis direction and the Y-axis direction. Among five LED surrounding portions 621, LED surrounding portions 621 that are arranged at the center in the X-axis direction are each formed by two separated supporting members 617S adjacent to each other in the X-axis direction. Moreover, an optical member contacting portion 622 is separated into two parts in the X-axis direction. The above configuration achieves the same operational advantage as that of the sixth embodiment described above. Note that FIG. 15 illustrates a terminal position of every LED surrounding portion 621 by alternate long and short dashed lines.

### Eighth Embodiment

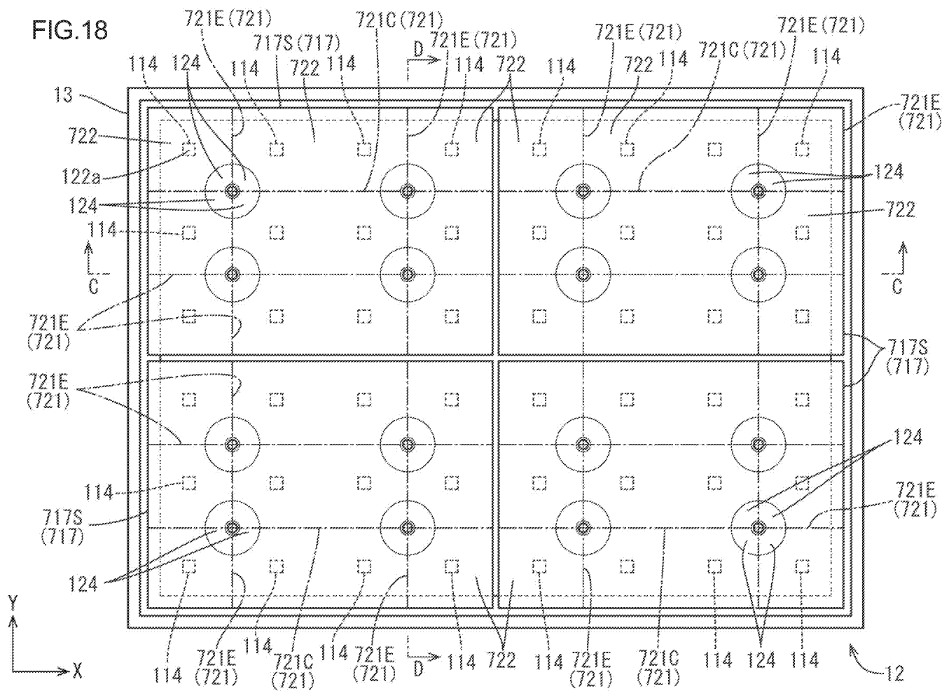

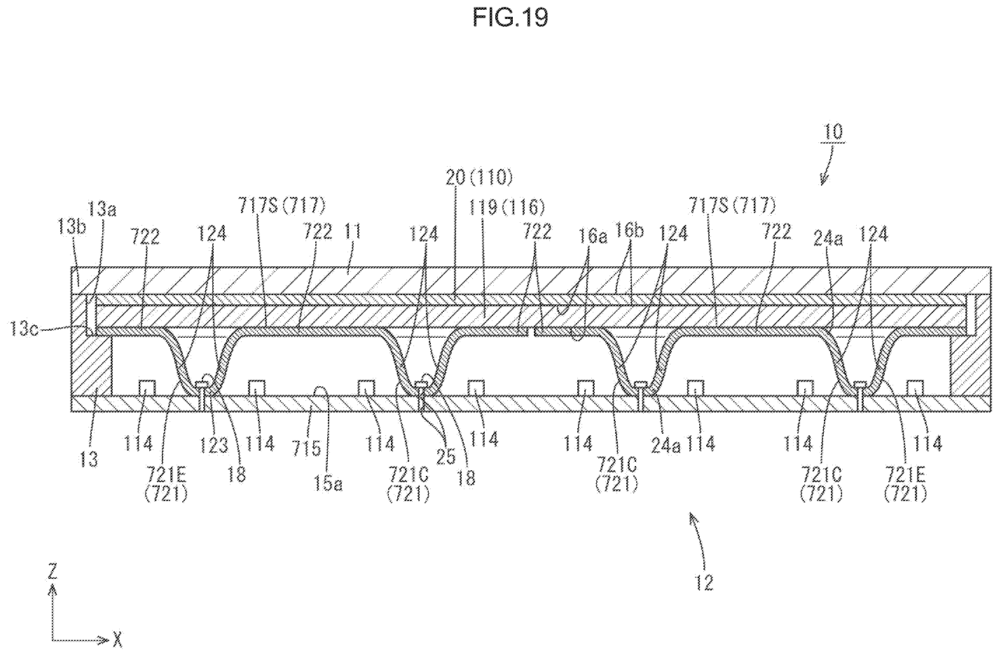

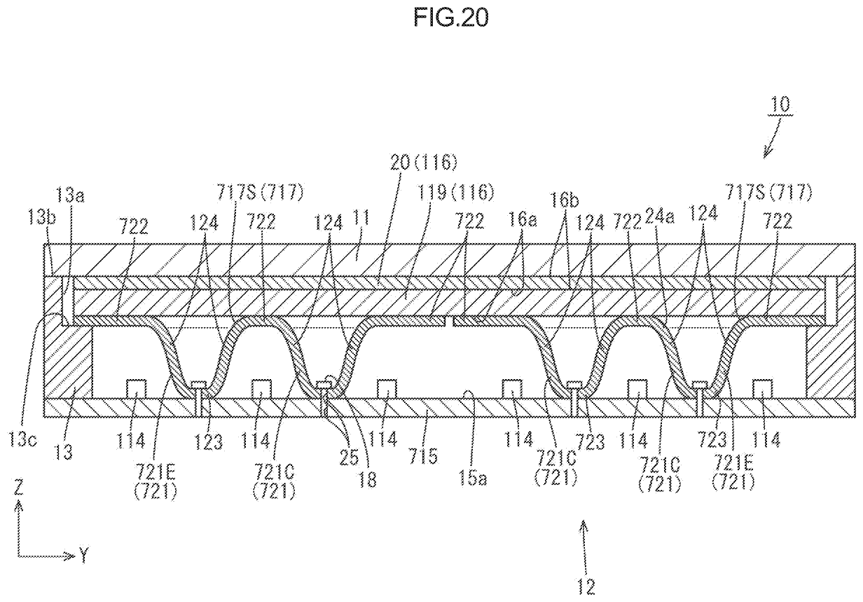

The following describes an eighth embodiment of the present invention with FIGS. 18 to 20. The eighth embodiment illustrates a variation in configuration of a supporting member portion 717 based on the second embodiment described above. Here, the description of the configuration and operational advantage common to that of the second embodiment described above is to be omitted.

As illustrated in FIGS. 18 to 20, the supporting member portion 717 according to this embodiment is formed by a plurality of separated supporting members 717S as in the fifth to seventh embodiments described above. Specifically, the number by which the separated supporting member 717S is separated is four, which number is equal to that in the seventh embodiment described above. Among five LED surrounding portions 721, LED surrounding portions 721 (including central LED surrounding portions 721C and terminal LED surrounding portions 721E) that are arranged at the center in the X-axis direction and the Y-axis direction, respectively, are formed by two separated supporting members 717S adjacent to each other in the X-axis direction and the Y-axis direction. Moreover, an optical member contacting portion 722 is separated into two parts in the X-axis direction and the Y-axis direction. The above configuration achieves the same operational advantage as that of the seventh embodiment described above. Note that FIG. 18 illustrates a terminal position of every LED surrounding portion 721 by alternate long and short dashed lines.

### Other Embodiments

The present invention is not limited to the embodiments described above with the description and the drawings. Such embodiments as under are contained in the technical scope of the present invention.

(1) In the embodiments described above, the optical member spacer in the LED surrounding portion includes the curved portion. Alternatively, the optical member spacer may be formed by only a linear portion without any curved portion.

(2) In the embodiments described above, the optical member spacer in the LED surrounding portion is oblique with respect to the optical member contacting portion and the substrate contacting portion. Alternatively, the optical member spacer may be perpendicular with respect to the optical member contacting portion and the substrate contacting portion.

(3) In the embodiments described above, the LED surrounding portion includes the optical member contacting portion. Alternatively, the optical member spacer may be disposed at a region of the supporting member other than the LED surrounding portion.

(4) In the embodiments described above, the LED surrounding portion includes the substrate contacting portion. Alternatively, the substrate contacting portion may be disposed at a region of the supporting member other than the LED surrounding portion.

(5) In the second embodiment described above, the LED surrounding portion surrounds the LEDs without any closed space between the LED surrounding portion and the LED substrate. Alternatively, the LED surrounding portion may surround the LEDs while including a closed space between the LED surrounding portion and the LED substrate.

(6) In the third and fourth embodiments described above, the LED surrounding portion surrounds the two LEDs arranged in the X-axis direction collectively. Alternatively, the LED surrounding portion may surround three or more LEDs arranged in the X-axis direction collectively.

(7) Other than the fifth to eighth embodiments described above, appropriate variation is applicable to a specific number and a specific position by which and at which the supporting member is separated for obtaining the separated supporting members.

(8) In the embodiments described above, only one LED substrate is used. Alternatively, two or more LED substrates are adoptable.

(9) Other than the embodiments described above, appropriate variation is applicable to the number and intervals of the LEDs bonded on the LED substrate.

(10) Other than the embodiments described above, appropriate variation is applicable to a specific number, specific arrangement of the fixing members as well as attachment of the fixing member to the LED substrate.

(11) In the embodiments described above, the supporting member supports the diffuser plate as the optical member. Alternatively, the supporting member may support the optical sheet as the optical member.

(12) In the embodiments described above, the casing has a box shape. Alternatively, the casing may include a bottom portion supporting the LED substrate on its rear side and may have a box shape in its entirety including an opening on its front side.

(13) It is off course possible to combine the technical matters described in the embodiments appropriately.

(14) The embodiments described above each discloses the case where the LED is used as the light source. Alternatively, an element other than the LED, such as an organic electro luminescence (EL) is available as the light source.

(15) The embodiments described above each discloses the case where the liquid crystal panel and the back light device are fixed with the light-blocking fixing tape or the transparent adhesive member. Alternatively, the liquid crystal panel and the back light device can be fixed with a frame bezel that is configured to be attached to a front side with respect to the liquid crystal panel.

(16) In the embodiments described above, the liquid crystal display device (liquid crystal panel or the back light device) has the planar shape of the longitudinal rectangle. Alternatively, the planar shape of the liquid crystal display device may be a vertical rectangle, a square, a circle, a semicircle, an ellipse, an oval, and a trapezoid.

(17) Other than the embodiments described above, appropriate variation is applicable to a specific number, a type, and a lamination order of optical members used for the back light device.

(18) In the embodiments described above, the color filters of the liquid crystal panel are formed by three colors of red, green, and blue as one example. The present invention is also applicable to a liquid crystal panel including color filters formed by four colors of yellow or white in addition to red, green, and blue.

(19) In the embodiments described above, the TFT is used as the switching element of the liquid crystal panel. Alternatively, the present invention is applicable to a liquid crystal panel with a switching element other than the TFT (e.g., a thin film diode (TFD)). Moreover, the present invention is also applicable to a liquid crystal panel configured to perform monochrome display in addition to one configured to perform color display.

(20) In the embodiments described above, the liquid crystal panel is exemplarily described as the display panel. Alternatively, the present invention is applicable to other types of display panels (e.g., micro electro mechanical systems (MEMS) display panel).

### EXPLANATION OF SYMBOLS

10: liquid crystal display device (display device)
11: liquid crystal panel (display panel)
12: back light device (lighting device)
14, 114, 214, 314, 414, 514: LED (light source)
15, 115, 215, 315, 415, 515, 615, 715: LED substrate (light source substrate)
16, 116, 216, 316, 416: optical member
17, 117, 217, 317, 417, 517, 617, 717: supporting member
18, 418, 518: fixing member
19, 119: diffuser plate (optical member)
21, 121, 221, 321, 421, 521, 621, 721: LED surrounding portion (light source surrounding portion)
22, 122, 222, 322, 422, 522, 622, 722: optical member contacting portion
23, 123, 423, 523: substrate contacting portion
24, 124: optical member spacer
417S, 517S, 617S, 717S: separated supporting member

1. A lighting device, comprising:
a light source;
a light source substrate on which the light source is mounted;
an optical member disposed to face the light source substrate while having a gap therebetween; and
a supporting member being transmissive and disposed between the light source substrate and the optical member and configured to support the optical member and including at least a light source surrounding portion, the light source surrounding portion and the light source substrate surrounding the light source therebetween.

2. The lighting device according to claim 1, wherein the light source surrounding portion includes at least an optical member contacting portion configured to contact the optical member.

3. The lighting device according to claim 2, wherein the optical member contacting portion extends in parallel to a surface of the optical member such that at least a portion of the optical member contacting portion overlaps the light source.

4. The lighting device according to claim 3, wherein
the light source includes light sources that are arranged at intervals within a surface area of the light source substrate, and
the light source surrounding portion is arranged in such a manner as to surround the light sources collectively, and the optical member contacting portion extends such that at least a portion of the optical member contacting portion extends across the light sources.

5. The lighting device according to claim 2, wherein
the light source surrounding portion includes at least an optical member spacer that is continuous from the optical member contacting portion and spaced apart from the optical member toward the light source substrate, and
the optical member spacer has a curved sectional shape.

6. The lighting device according to claim 1, wherein the light source surrounding portion includes at least a substrate contacting portion configured to contact the light source substrate.

7. The lighting device according to claim 6, wherein
the light source includes light sources that are arranged at intervals within a surface area of the light source substrate in rows and columns, and the lighting device further comprising:
fixing members arranged two-dimensionally in a staggered manner with respect to the light sources to fix the substrate contacting portion to the light source substrate.

8. The lighting device according to claim 1, wherein
the light source includes light sources that are arranged at intervals within a surface area of the light source substrate in rows and columns, and
the light source surrounding portion extends along a row direction or a column direction of the light sources so as to surround the light sources collectively.

9. The lighting device according to claim 1, wherein
the light source includes light sources and the light source surrounding portion includes light source surrounding portions, and the light sources and the light source surrounding portions are arranged within a surface area of the light source substrate in rows and columns, and
the light source surrounding portions at least include optical member contacting portions, respectively, that are configured to contact the optical member, and the optical member contacting portions that are adjacent to each other are connected to each other.

10. The lighting device according to claim 1, wherein
the light source surrounding portion at least includes an optical member contacting portion configured to contact the optical member, and a substrate contacting portion configured to contact the light source substrate, and
the supporting member includes a plurality of separated supporting members obtained by separating the optical member contacting portion.

11. A display device, comprising:
the lighting device according to claim 1; and
a display panel configured to display an image with use of light exiting from the lighting device.
